(19) United States
(12) Patent Application Publication
(10) Pub. No.: US 2026/0342158 A1
(43) Pub. Date: Oct. 29, 2026

(54) STATOR OF MOTOR

(71) Applicant: LG ELECTRONICS INC., Seoul (KR)

(72) Inventors: Jaewon KIM, Seoul (KR); Hakjung KIM, Seoul (KR); Sangjoon EUM, Seoul (KR); Songe PARK, Seoul (KR); Kyungho HA, Seoul (KR)

(21) Appl. No.: 19/558,732

(22) Filed: Mar. 6, 2026

(30) Foreign Application Priority Data
Apr. 29, 2025 (KR) 10-2025-0056589

(51) Int. Cl. H02K 3/02; H02K 1/14; H02K 3/12; H02K 3/52

(52) U.S. Cl. CPC H02K 3/02; H02K 1/146; H02K 3/12; H02K 3/522

(57) ABSTRACT

A stator of a motor is disclosed. The stator of the motor includes a stator core including a plurality of unit cores connected to each other to be formed in an annular shape, and a stator coil wound around each of the plurality of unit cores, and the plurality of unit cores are made of materials having different magnetic flux densities. Accordingly, iron loss is reduced using a material having a high magnetic flux density, and the use amount of a relatively high-priced material is reduced, thereby minimizing an increase in material cost.

### CROSS-REFERENCE TO RELATED APPLICATION

Pursuant to 35 U.S.C. § 119(a), this application claims the benefit of the earlier filing date and the right of priority to Korean Patent Application No. 10-2025-0056589, filed on Apr. 29, 2025, the contents of which are incorporated by reference herein in their entirety.

### BACKGROUND

### 1. Field

This disclosure relates to a stator of a motor.

### 2. Description of the Related Art

In general, a stator functions to make a magnetic force by magnetizing an iron core in a motor, and generates a rotational force through an interaction of the stator with a rotor. In order to make the magnetic force, a magnetic field is formed by winding a coil around the iron core (stator core). Therefore, most of stators require a structure in which the coil is further filled in a slot of the stator core so as to improve efficiency or output density.

Conventionally, a core (hereinafter, referred to as a 'whole core') obtained by integrally forming a stator core of a motor was used. This had an advantage that the reliability of a manufacturing process was excellent, but had a problem that, as a space of a nozzle for coil winding should be secured, the effective area of a slot having a stator coil wound therein was decreased to that extent, and therefore, the efficiency of the motor was deteriorated.

By considering this, there has been proposed a core (hereinafter, referred to as a 'folding type core' or 'folding core') obtained by winding a stator coil by unfolding long a stator core constituting a stator of a motor and then forming the stator core in a cylindrical shape by rolling the stator core or a core (hereinafter, referred to as a 'split core') obtained by splitting a stator core, winding a stator coil around each split stator core, and then assembling the split stator cores.

Patent Document 1 (WO2024-244708 A1) discloses an example of the split core. In the split core disclosed in Patent Document 1, each unit core is formed by laminating a plurality of electrical steel sheets (hereinafter, referred to as silicon steel sheets).

The silicon steel sheet is mainly composed of iron (Fe) and silicon (Si), the content of the silicon is generally between 0.5% and 6.5%, and electrical characteristics are improved according to the content of the silicon. In addition, since the silicon steel sheet has high electrical resistance and low loss, the silicon steel sheet is mainly used for transformers, motors, and the like.

However, in the conventional split core described above, as each unit core is made of a same material, i.e., a silicon steel sheet, there may be a limitation in reducing iron loss to that extent. Besides, the magnetic flux density of the silicon steel sheet is limited due to characteristics of the silicon steel sheet, and hence the area of a slot is decreased as the tooth width of the unit core is increased to that extent. Therefore, copper loss may occur as the diameter of a stator coil becomes small as compared with the number of turns of the stator coil.

### SUMMARY

Therefore, the present disclosure provides a stator of a motor, which can reduce iron loss and/or copper loss as compared with the same outer diameter.

The present disclosure also provides a stator of a motor, which can reduce iron loss by optimizing materials of a stator core.

The present disclosure also provides a stator of a motor, which can reduce copper loss by enlarging a slot area of a stator core.

In order to achieve these and other advantages and in accordance with the purpose of this specification, as embodied and broadly described herein, there is provided a stator of a motor, including a stator core and a stator coil. The stator core may include a plurality of unit cores connected to each other to be formed in an annular shape. The stator coil may be wound around each of the plurality of unit cores. The plurality of unit cores may be made of materials having different magnetic flux densities. Accordingly, iron loss is reduced using a material having a high magnetic flux density, and the use amount of a relatively high-priced material is reduced, thereby minimizing an increase in material cost.

In an example, the plurality of unit cores may include a first unit core and the second unit core. The first unit core may have a first magnetic flux density, and the second unit core may have a second magnetic flux higher than the first magnetic flux density. Accordingly, iron loss in the stator core can be reduced, and an increase in material cost can be minimized.

For example, the first unit core and the second unit core may be alternately arranged along a circumferential direction. Accordingly, magnetic flux saturation in the stator core is reduced, thereby improving motor efficiency and suppressing an increase in material cost due to the improvement of the motor efficiency.

Alternatively, the first unit core may include a first unit yoke and a first tooth extending from the first unit yoke. The second unit core may include a second unit yoke and a second tooth extending from the second unit yoke. A second tooth width defined as a width length between both circumferential ends of the second tooth may be formed smaller than a first tooth width defined as a width length between both circumferential ends of the first tooth. Accordingly, the use amount of the second unit core which is relatively high-priced, and the slot area of the second unit core is widened, thereby enlarging a coil wire diameter of a second stator coil wound around the second unit core.

Specifically, a first yoke distance defined as a distance from a center of the stator core to an inner circumferential surface of each of both ends of the first unit yoke may be formed equal to a second yoke distance defined as a distance from the center of the stator core to an inner circumferential surface of each of both ends of the second unit yoke.

More specifically, a first tooth length defined as a length from an inner circumferential surface of the first tooth to the inner circumferential surface of the first unit yoke may be formed smaller than a second tooth length defined as a length from an inner circumferential surface of the second tooth to the inner circumferential surface of the second yoke.

In another example, a first yoke end width defined as a radial width of each of both ends of the first yoke and a second yoke end width defined as a radial width of each of both ends of the second unit yoke, which faces the end of the first yoke, may be formed to be the same. Accordingly, although the first unit yoke is made of a material a relatively low magnetic flux density, occurrence of magnetic flux saturation in the first unit yoke can be suppressed.

For example, a first yoke middle width defined as a radial width of the first unit yoke at a point at which the inner circumferential surface of the first unit yoke and a side surface of the first tooth meet each other may be formed larger than a second yoke middle width defined as a radial width of the second yoke at a point at which the inner circumferential surface of the second unit yoke and a side surface of the second tooth meet each other. Accordingly, the slot area of the second unit core is enlarged if possible, thereby enlarging the coil wire diameter of the second stator coil with respect to the same number of turns.

In still another example, a first internal angle between the first unit yoke and the first tooth may be formed larger than a second internal angle between the second unit yoke and the second tooth. Accordingly, a slot length of the second unit core is enlarged, thereby securing a slot area of the second unit core as wide as possible.

For example, the first internal angle may be formed as an obtuse angle, and the second internal angle may be formed as a right angle. Accordingly, a slot area of the second unit core can be secured wider than a slot area of the first unit core.

In still another example, in the plurality of unit cores, teeth widths of teeth between unit cores made of different material may be formed different from each other. Coil wire diameters of the stator coil wound around the unit cores having the different teeth widths may be formed different from each other. Accordingly, copper loss in the stator coil with respect to the same number of turns is minimized, thereby improving the motor efficiency.

For example, the plurality of unit cores may include a first unit core and a second unit core. The second unit core may have a magnetic flux density higher than a magnetic flux density of the first unit core. A coil wire diameter of a second stator coil wound around the second unit core may be formed larger than a coil wire diameter of a first stator coil wound around the first unit core. Accordingly, copper loss in the second stator coil is minimized, thereby improving the motor efficiency.

Specifically, an insulator may be located on each of both axial side surfaces of the stator core. The insulator may include a plurality of terminals, and the first stator coil and the second stator coil may be connected to each other by a connection coil in at least one terminal among the plurality of terminals. Accordingly, although the coil wire diameter of the first stator coil and the coil wire diameter of the second stator coil are different from each other, the first stator coil and the second stator coil can be smoothly connected to each other.

In addition, the insulator may include a terminal that allows both ends of the connection coil connecting between the first stator coil and the second stator coil to be respectively connected to the first stator coil and the second stator coil. Accordingly, although the coil wire diameter of the first stator coil and the coil wire diameter of the second stator coil are different from each other, the first stator coil and the second stator coil can be smoothly connected to each other.

In addition, a coil wire diameter of the connection coil may be formed equal to the coil wire diameter of the first stator coil. Accordingly, copper loss in the connection coil is reduced if possible, thereby improving the motor efficiency.

In still another example, the first unit core may be made of a silicon steel sheet, and the second unit core may be made of a cobalt steel sheet. Accordingly, the motor efficiency can be improved, and an increase in material cost can be suppressed.

In this case, a number of turns of a coil wound around the first unit core and a number of turns of a coil wound around the second unit core may be formed to be the same. Accordingly, motor efficiency and stability can be ensured.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view showing a stator according to an embodiment;

FIG. 2 is a plan view of the stator according to FIG. 1;

FIG. 3 is a perspective view showing a stator core according to this embodiment;

FIG. 4 is a plan view showing the stator core of FIG. 3;

FIG. 5 is an enlarged plan view showing a portion of the stator core of FIG. 4;

FIG. 6 is an enlarged plan view showing a state in which a coil is wound around the stator core according to this embodiment;

FIG. 7 is an enlarged perspective view showing a connection structure of a stator coil in the stator according to this embodiment;

FIG. 8 is a schematic view illustrating a connection state of the stator coil according to this embodiment; and

FIG. 9 is a table comparing efficiency and material cost for each arrangement of a first unit core and a second unit core in the stator according to this embodiment.

### DETAILED DESCRIPTION OF THE EMBODIMENTS

Hereinafter, a stator of a motor according to the present disclosure will be described in detail, based on embodiments illustrated in the accompanying drawings.

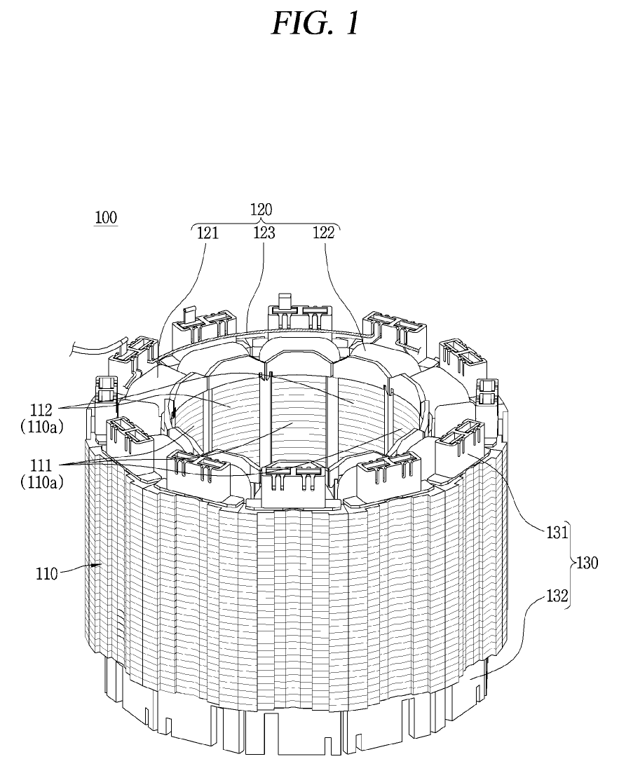

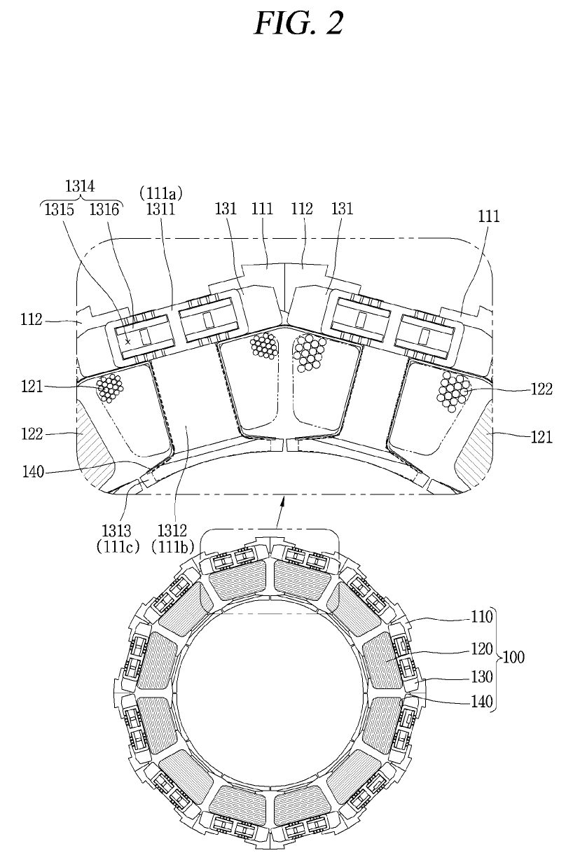

FIG. 1 is a perspective view showing a stator according to an embodiment, and FIG. 2 is a plan view of the stator according to FIG. 1.

Referring to FIGS. 1 and 2, a stator 100 of a motor according to an embodiment may include a stator core 110, a stator coil 120, an insulator 130, and an insulating sheet 140. The stator core 110 is a member that forms a magnetic path, the stator coil 120 is a member that allows the magnetic path to be formed in the stator core 110, the insulator 130 is a member that insulates an axial side surface of the stator core 110, and the insulating sheet 140 is a member that insulates an inner circumferential surface of the stator core 110.

The stator core 110 may be formed in an annular shape as a plurality of unit cores 110a having a plurality of steel sheets laminated therein are connected to each other. In other words, the stator core 110 constituting a split core may be formed in an annular shape as each of a plurality of unit cores 110a having a plurality of steel sheets laminated in an axial direction therein is post-assembled with another unit core 110a adjacent in a circumferential direction thereto.

In this case, the plurality of unit cores 110a made of different materials, e.g., having different magnetic flux densities may be alternately arranged along the circumferential direction. For example, the plurality of unit cores 110a may include two kinds of unit cores 110a having a characteristic in which magnetic flux densities thereof are different from each other, and, in a plurality of unit cores 110a made of two kinds of different materials, a plurality of, e.g., three unit cores 110a made of a same material may be arranged in the circumferential direction alternately with another plurality of, e.g., three unit cores 110a made of another same material. In some cases, the plurality of unit cores 110a may include three or more kinds of unit cores. In this embodiment, an example is mainly described in which a plurality of unit cores 110a and 110a made of two kinds of different materials are alternately arranged one by one along the circumferential direction.

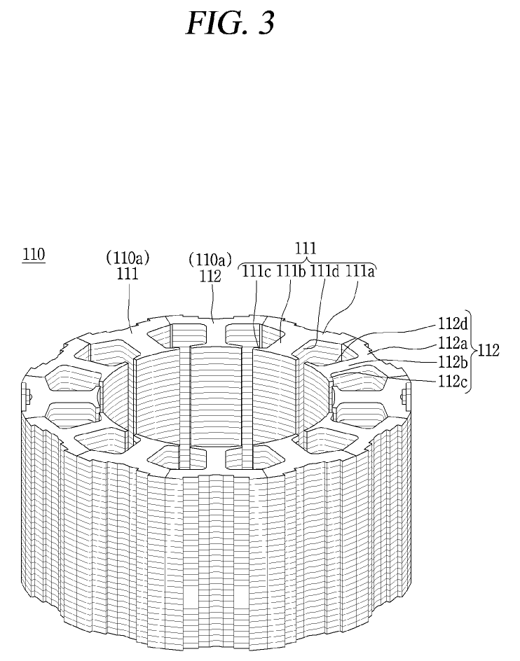

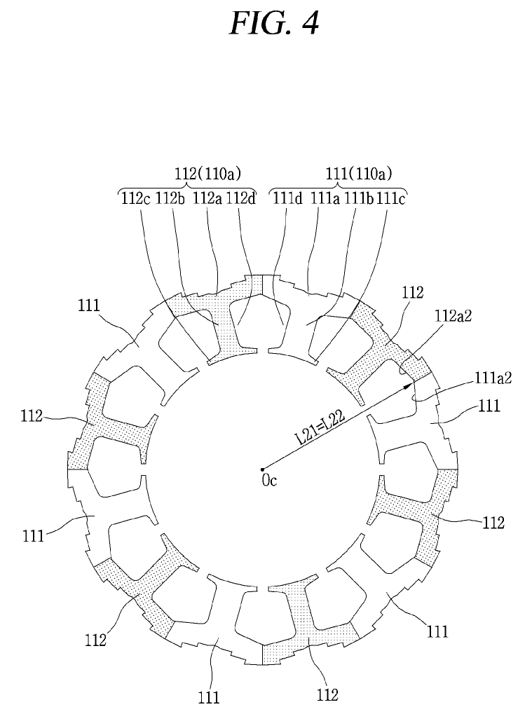

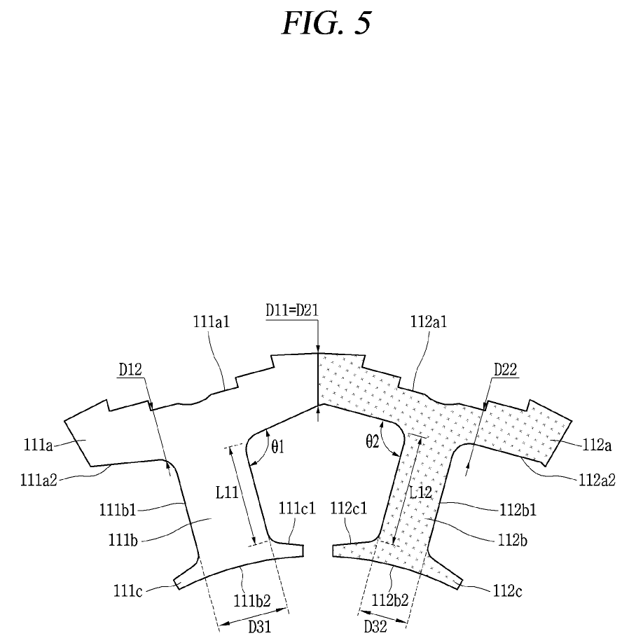

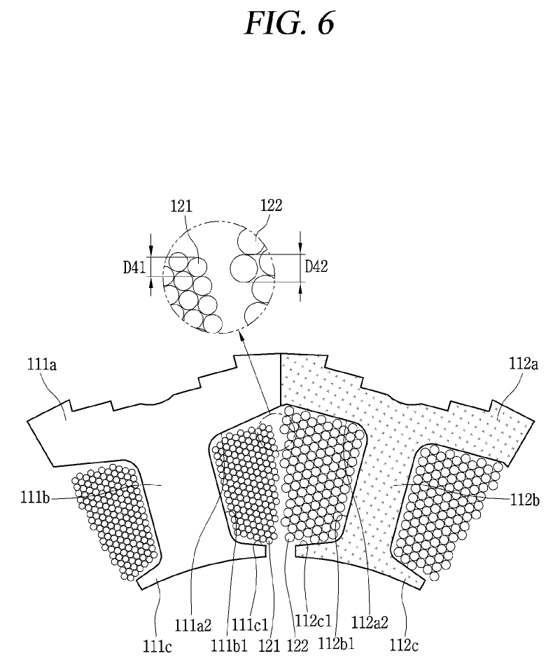

FIG. 3 is a perspective view showing the stator core according to this embodiment, FIG. 4 is a plan view showing the stator core of FIG. 3, FIG. 5 is an enlarged plan view showing a portion of the stator core of FIGS. 4, and 6 is an enlarged plan view showing a state in which a coil is wound around the stator core according to this embodiment.

Referring to FIGS. 3-5, the plurality of unit cores 110a may include first unit cores 111 having a first magnetic flux density and second unit cores 112 having a second magnetic flux density. The first unit core 111 may be made of a material, e.g., a silicon steel sheet, which has a magnetic flux density relatively lower than the magnetic flux density of the second unit core 112, and the second unit core 112 may be made of a material, e.g., a cobalt steel sheet, which has a magnetic flux density relatively higher than the magnetic flux density of the first unit core 111. Basic shapes of the first unit core 111 and the second unit core 112 are similar to each other. Therefore, hereinafter, same portions of the first unit core 111 and the second unit core 112 are described based on the first unit core 111, and description of the second unit core 112 is replaced with that of the first unit core 111.

For reference, the cobalt steel sheet is mainly composed of iron (Fe) and cobalt (Co), the content of the cobalt is between 5% and 30% according to applied industrial fields, and the performance of the cobalt steel sheet is maintained since the cobalt steel sheet has high magnetic susceptibility and magnetic stability. The cobalt steel sheet is mainly used for high-performance magnets or electronic devices. However, while the cobalt steel sheet has high performance as compared with the silicon steel sheet, the cobalt steel sheet is relatively expensive as compared with the silicon steel sheet.

Each of the first unit cores 111 according to this embodiment may include a first unit yoke 111a, a first tooth 111b, a first shoe 111c, and first slots 111d. Each of the first unit yoke 111a, the first tooth 111b, and the first shoe 111c may be formed inside the first unit core 111, and the first slot 111d may be formed outside the first unit core 111 to form one slot together with a second slot 112d of the second unit core 112, which is adjacent thereto.

The first unit yoke 111a may be formed in an arc shape. For example, an outer circumferential surface 111a1 of the first unit yoke 111a may be formed in an uneven arc shape, and an inner circumferential surface 111a2 of the first unit yoke 111a may be formed as a linear surface intersecting, at an obtuse angle, a circumferential side surface 111b1 of the first tooth 111b to be described later. For example, the first unit yoke 111a may be formed such that a first internal angle θ1 between the inner circumferential surface 111a2 of the first unit yoke 111a and one circumferential side surface 111b1 of the first tooth 111b becomes an obtuse angle of substantially 100 degrees. Therefore, a first tooth length L11 defined as a radial length of the first tooth 111b to be described later may be formed smaller than a second tooth length L12 defined as a radial length of a second tooth 112b.

Referring to FIGS. 4 and 5, the first unit yoke 111a may be formed such that radial widths of portions thereof with the first tooth 111b to be described later, interposed therebetween, are formed to be almost the same along the circumferential direction. For example, the first unit yoke 111a may be formed such that a first yoke end width D11 defined as a radial width of each of both circumferential ends thereof is the same or almost the same as a first yoke middle width D12 defined as a radial width of the first unit yoke 111a at a point at which the first unit yoke 111a and the first tooth 111b meet each other. Accordingly, although the first unit core 111 is made of the silicon steel sheet having a relatively low magnetic flux density, magnetic flux saturation between the first tooth 111b and the first unit yoke 111a can be suppressed.

In this case, the first yoke middle width D12 may be formed larger than a second yoke middle width D22 to be described later. In other words, the first yoke end width D11 may be formed equal to a second yoke end width D21 to be described later, and the first yoke middle width D12 may be formed larger than the second yoke middle width D22. Accordingly, magnetic flux flow from the first tooth 111b to the first unit yoke 111a is smoothly made as described above, so that occurrence of magnetic flux saturation in the first unit yok 111a can be suppressed.

Also, in this case, the inner circumferential surface 111a2 of the first unit yoke 111a may be formed to be located with an inner circumferential surface 112a2 of a second unit yoke 112a on the same circumferential line. In other words, a first yoke distance L21 defined as a distance from a center Oc of the stator core 110 to the inner circumferential surface 111a2 of each of both ends of the first unit yoke 111a may be formed equal to a second yoke distance L22 defined as a distance from the center Oc of the stator core 110 to the inner circumferential surface 111a2 of each of both ends of the second unit yoke 112a to be described later. Accordingly, a slot area of the first slot 111d and/or a slot area of the second slot 112d can be maximally secured, thereby increasing a space factor of the stator coil 120.

The first tooth 111b may be formed in a rectangular shape having a same width along a length direction. For example, the first tooth 111b may extend in a radial direction toward an inner side from the middle of the inner circumferential surface 111a2 of the first unit yoke 111a. Therefore, as a first tooth width D31 defined as a width length between both circumferential ends of the first tooth 111b is formed shorter than a length between both the ends of the first unit yoke 111a, the first slot 111d forming a coil winding space may be formed between the first tooth 111b and the second tooth 112b adjacent thereto.

Referring to FIGS. 4 and 5, the first tooth 111b may be formed shorter than the second tooth 112b to be described later. In other words, the first tooth length L11 defined as a length from an inner circumferential surface 111b2 of the first tooth 111b to the inner circumferential surface 111a2 of the first unit yoke 111a may be formed smaller than the second tooth length L12 defined as a length from an inner circumferential surface 112b2 of the second tooth 112b to be described later to the inner circumferential surface 112a2 of the second unit yoke 112a to be described later. Therefore, even when the first yoke end width D11 of the first unit yoke 111a is formed equal to the second yoke end width D21 of the second unit yoke 112a as described above, the first yoke middle width D12 may be formed equal to the first yoke end width D11. Accordingly, although the first unit yoke 111a is made of a material having a relatively low magnetic flux density, occurrence of magnetic flux saturation in the first unit yok 111a can be suppressed.

The first shoe 111c may be formed in an arc shape. For example, the first shoe 111c extends to both circumferential sides from an inner end of the first tooth 111b, and a circumferential length of the first shoe 111c may be formed shorter than a circumferential length of the first unit yoke 111a. In other words, while, the first unit yoke 111a is in contact with the second unit yoke 112a adjacent thereto, the first shoe 111c may be spaced apart from a second shoe 112c adjacent thereto by a predetermined interval. Therefore, the stator coil 120 may be wound around the first tooth 111b of the stator core 110 while a winding nozzle is input to and output from an inner circumferential side of the stator core 110.

The first slot 111d is a space in which the stator coil 120 is wound, and may be formed by the inner circumferential surface 111a2 of the first unit yoke 111a, the circumferential side surface 111b1 of the first tooth 111b, and an outer circumferential surface 111c1 of the first shoe 111c. In other words, the first slots 111d may be formed at both the circumferential sides with the first tooth 111b interposed therebetween, respectively. Therefore, the first slot 111d of the first unit core 111 along with the second slot 112d of the second unit core 112 adjacent thereto in the circumferential direction may form one slot.

Referring to FIGS. 3-5, each of the second unit cores 112 according to this embodiment may include the second unit yoke 112a, the second tooth 112b, the second shoe 112c, and the second slots 112d. A basic shape of the unit core 112 may be formed to be the same as the first unit core 111 as described above. In other words, the second unit yoke 112a may be formed to correspond to the first unit yoke 111a, the second tooth 112b may be formed to correspond to the first tooth 111b, the second shoe 112c may be formed to correspond to the first shoe 111c, and the second slot 112d may be formed to correspond to the first slot 111d. Therefore, each of the second unit yoke 112a, the second tooth 112b, and the second shoe 112c may be formed inside the second unit core 112, and the second slot 112d may be formed outside the second unit core 112 to form one slot together with the first slot 111d of the first unit core 111, which is adjacent thereto.

Referring to FIGS. 4 and 5, the second unit yoke 112a may be formed in an arc shape like the first unit yoke 111a. For example, an outer circumferential surface 112a1 of the second unit yoke 112a may be formed in an uneven arc shape like the outer circumferential surface 111a1 of the first unit yoke 111a, and the inner circumferential surface 112a2 of the second unit yoke 112a may be formed as a linear surface like the inner circumferential surface 111a2 of the first unit yoke 111a. Therefore, an arc length of the second unit yoke 112a may be formed equal to an arc length of the first unit yoke 111a.

In other words, the inner circumferential surface 112a2 of the second unit yoke 112a may be formed as a linear surface perpendicular to a circumferential side surface 112b1 of the second tooth 112b. For example, the second unit yoke 112a may be formed such that a second internal angle θ2 between the inner circumferential surface 112a2 of the second unit yoke 112a and one circumferential side surface 112b1 of the second tooth 112b forms a right angle. Therefore, the second tooth length L12 defined as the radial length of the second tooth 112b to be described later may be formed larger than the above-described radial length, i.e., the first tooth length L11 of the first tooth 111b. Accordingly, the slot area of the second slit 112d to be described later expands larger than the slot area of the first slot 111d, so that a coil wire diameter with respect to a same number of turns of the stator core 110 can be enlarged. Then, as magnetic flux saturation in the second stator coil 122 to be described later is reduced, copper loss in the stator coil 120 is reduced, so that motor efficiency can be improved.

The second unit yoke 112a may be formed such that radial widths of portions thereof with the second tooth 112b to be described later, interposed therebetween, gradually increase along the circumferential direction. For example, the second unit yoke 112a may be formed such that the second yoke end width D21 defined as the radial width of each of both the circumferential ends thereof is formed larger than the second yoke middle width D22 defined as the radial width of the second unit yoke 112a at a point at which the second unit yoke 112a and the second tooth 112b meet each other. Accordingly, as the second unit yoke 112a is made of the cobalt steel sheet having a relatively high magnetic flux density even though a middle portion of the second unit yoke 112a is formed narrower than both end portions of the second unit yoke 112a, magnetic flux saturation between the second tooth 112b and the second unit yoke 112a can be suppressed.

In this case, the second yoke distance L22 defined as the distance from the center Oc of the stator core 110 to the inner circumferential surface 112a2 of each of both the ends of the second unit yoke 112a may be formed equal to the first yoke distance L21 defined as the distance from the center Oc of the stator core 110 to the inner circumferential surface 111a2 of each of both the ends of the first unit yoke 111a. Accordingly, the outer circumferential surface 112a1 and the inner circumferential surface 112a2 of the second unit yoke 112a may be located on the same circumferential line with the outer circumferential surface 111a1 and the inner circumferential surface 111a2 of the first unit yoke 111a, which face the outer circumferential surface 112a1 and the inner circumferential surface 112a2 of the second unit yoke 112a, respectively. Accordingly, magnetic flux saturation between the first unit yoke 111a and the second unit yoke 112a is effectively suppressed, so that deterioration of motor efficiency can be prevented.

The second tooth 112b may be formed in a rectangular shape having a same width along a length direction like the first tooth 111b. For example, the second tooth 112b may extend in the radial direction toward an inner side from the middle of the inner circumferential surface 112a2 of the second unit yoke 112a. Therefore, as a second tooth width D32 defined as a width length between both circumferential ends of the second tooth 112b is formed shorter than a length between both the ends of the second unit yoke 112a, the second slot 112d forming a coil winding space may be formed between the second tooth 112b and the first tooth 111b adjacent thereto.

In this case, the second tooth width D32 may be formed smaller than the first tooth width D31. In other words, as the second magnetic flux density of the second unit core 112 is formed higher than the first magnetic flux density of the first unit core 111, magnetic flux saturation in the second tooth 112b does not increase as compared with magnetic flux saturation in the first tooth 111b even though the second tooth 112b is formed thinner than the first tooth 111b. Therefore, the second tooth width D32 of the second unit core 112 may be formed smaller than the first tooth width D31 of the first unit core 111. Accordingly, iron loss in the stator core 110 is reduced using the cobalt steel sheet having a high magnetic flux density, and the use amount of the cobalt steel sheet that is a relatively high-priced is minimized, thereby minimizing an increase in material cost of the stator core 110.

Referring to FIG. 6, as the second tooth width D32 of the second unit core 112 is formed smaller than the first tooth width D31 of the first unit core 111, the slot area of the second slot 112d may become wider than the slot area of the first slot 111d. Therefore, when a number of turns of a first stator coil 121 wound around the first unit core 111 and a number of turns of a second stator coil 122 wound around the second unit core 112 are the same, a coil wire diameter D42 of the second stator coil 122 may be formed larger than a coil wire diameter D41 of the first stator coil 121. Accordingly, as copper loss in the second stator coil 122 is reduced, copper loss in the entire stator coil is reduced, so that motor efficiency can be improved. In other words, the number of turns of the first stator coil 121 and the number of turns of the second stator coil 122 are formed to be the same, and the coil wire diameter D42 of the second stator coil 122 may be formed thicker than the coil wire diameter D41 of the first stator 121.

Referring to FIG. 5, the second tooth 112b may be formed longer than the above-described first tooth 111b. In other words, the second tooth 112b may be formed such that the inner circumferential surface 112a2 of the second unit yoke 112a is perpendicular to the second tooth 112b in a state in which the inner circumferential surface 112a2 of the second unit yoke 112a is located on the same circumferential line with the inner circumferential surface 111a2 of the first unit yoke 111a. Therefore, the second tooth length L12 as the length from the inner circumferential surface 112b2 of the second tooth 112b to the inner circumferential surface 112a2 of the second unit yoke 112a may be formed larger than the first tooth length L11 defined as the length from the inner circumferential surface 111b2 of the first tooth 111b to the inner circumferential surface 111a2 of the first unit yoke 111a. Accordingly, the slot area of the second slot 112d expands larger than the slot area of the first slot 111d as described above, so that the coil wire diameter 42 of the second stator coil 122 to be described later with respect to the same number of turns can be enlarged as compared with the coil wire diameter D41 of the first stator coil 121 to be described later with respect to the same number of turns. Then, magnetic flux saturation in the stator coil 120 is suppressed, so that motor efficiency can be improved to that extent.

Referring to FIGS. 3-5, the second shoe 112c according to this embodiment may be formed in an arc shape like the first shoe 111c. For example, the second shoe 112c extends to both circumferential sides from an inner end of the second tooth 112b, and a circumferential length of the second shoe 112c may be formed shorter than a circumferential length of the second unit yoke 112a. Therefore, the stator coil 120 may be wound around the second tooth 112b of the stator core 110 while the winding nozzle is input to and output from the inner circumferential side of the stator core 110.

Referring to FIGS. 3-5, the second slot 112d according to this embodiment is a space in which the stator coil 120 is wound, and may be formed by the inner circumferential surface 112a2 of the second unit yoke 112a, the circumferential side surface 112b1 of the second tooth 112b, and an outer circumferential surface 112c1 of the second shoe 112c. In other words, the second slots 112d may be formed at both the circumferential sides with the second tooth 112b interposed therebetween, respectively. Therefore, the second slot 112d along with the first slot 111d of the first unit core 111 adjacent thereto may form one slot as described above.

Referring to FIGS. 1 and 2, the stator coil 120 according to this embodiment may be accommodated in the first slot 111d and the second slot 112d while being wound around the first tooth 111b and the second tooth 112b of the stator core 110. For example, the stator coil 120 may include stator coils of three phases of U, V, W, and the like, and the stator coil 120 of each phase may include the first stator coil 121, the second stator coil 122, and a connection coil 123. The first stator coil 121 is a coil wound around the first tooth 111b of the first unit core 111, the second stator coil 122 is a coil wound around the second tooth 112b of the second unit core 112, and the connection coil 123 is a coil connecting between the first stator coil 121 and the second stator coil 122.

In this case, in the stator coil 120 of each phase, the first stator coil 121, the second stator coil 122, and the connection coil 123 may be made of a same material or may be made of different materials. In the case of the former, material cost and/or manufacturing cost of the stator coil 120 can be optimized. In the case of the latter, copper loss in the stator coil 120 is minimized, thereby improving motor efficiency. In this embodiment, an example is illustrated in which the first stator coil 121, the second stator coil 122, and the connection coil 123 in the stator coil 120 of each phase are made of a same material.

Also, in this case, in the stator coil 120 of each phase, which the first stator coil 121, the second stator coil 122, and the connection coil 123 may be formed with a same coil wire diameter or may be formed with different coil wire diameters. In the case of the former, a coil winding operation on the stator coil 120 can be easily performed. In the case of the latter, magnetic flux saturation in some coils (e.g., the second stator coil) is suppressed, so that the motor efficiency can be improved. In this embodiment, the case of the latter, i.e., an example in which the coil wire diameter D42 of the second stator coil 122 is formed larger than the coil wire diameter D41 of the first stator coil 121 is illustrated. In this case, a coil wire diameter of the connection coil 123 may be formed equal to or larger than the coil wire diameter D42 of the second stator coil 122. Accordingly, magnetic flux saturation in the connection coil 123 is suppressed, so that the motor efficiency can be improved.

The stator coil 120 is inserted into each of three phases (U, V, W) positions of a power terminal portion (no reference numeral) through winding nozzles of a winding machine (not shown), which are arranged at a constant interval in the axial direction, and is wound around each unit core while each winding nozzle repeatedly moves in horizontal and vertical directions at the same time. Then, after the stator coil 120 is wound around three unit cores, the winding nozzle moves horizontally by an interval of the three unit cores. Then, after the winding nozzle is moved to each slot 111d and 112d, the above winding operation is repeated. Then, the stator coil 120 is cut in a state in which the stator coil 120 is inserted into each of three phase positions of a neutral point.

Thereafter, the first stator coil 121 and the second stator coil 122 of each phase are connected to each other, using the connection coil 123 of each phase. The connection coil 123 of each phase may be made of a same material as the first stator coil 121 and/or the second stator coil 122 of each phase with a same wire diameter as the first stator coil 121 and/or the second stator coil 122 of each phase. For example, the connection coil 123 of the U phase may be made of a same material as the second stator coil 122 of the U phase, which is relatively thick, with a same wire diameter as the second stator coil 122 of the U phase. Accordingly, material cost of the connection coil 123 is reduced, and copper loss in the connection coil 123 is minimized, thereby improving the motor efficiency.

In this case, both ends of the connection coil 123 of each phase may be the first stator coil 121 and the second stator coil 122 of each phase by respective magmates 1316 in each terminal 1314. Therefore, although the first stator coil 121 and the second stator coil 122 of each phase, which have different coil wire diameters, are wound around different unit cores 111 and 112, respectively, the first stator coil 121 and the second stator coil 122 may be connected to teach other the connection coil 123. The magmate 1316 along with the terminal 1314 will be again described later.

Referring to FIGS. 1 and 2, the insulator 130 according to this embodiment may include a first insulator 131 and a second insulator 132. The first insulator 131 is an insulator located at one axial side, and the second insulator 132 is an insulator located at the other axial side. As the first insulator 131 and the second insulator 132 are formed to be almost the same, the first insulator 131 will be mainly described below.

For example, the first insulator 131 may be formed to correspond to each of the plurality of unit cores 110a. In other words, the first insulator 131 may be separated into single ones by a number of the unit cores 110a to be formed independently from each other, or a plurality of first insulators by a total number of the unit cores 110a may be formed to be connected to each other. In this embodiment, an example is illustrated in which the first insulator 131 is separated into single ones. Therefore, the first insulator 131 and/or the second insulator 132 may be understood as a single first insulator 131 and/or a single second insulator 132. Of course, in some cases, the first insulator 131 may refer to all first insulators 131 and the second insulator 132 may refer to all second insulators 132.

Specifically, the first insulator 131 may include a first yoke insulating portion 1311, a first tooth insulating portion 1312, a first shoe insulating portion 1313, and a terminal 1314. In other words, the single first insulator 131 may include a first yoke insulating portion 1311, a first tooth insulating portion 1312, a first shoe insulating portion 1313, and a terminal 1314. The first yoke insulating portion 1311 is a portion that insulates between the unit yokes 111a and 112a of the stator core 110 and the stator coil 120, the first tooth insulating portion 1312 is a portion that insulates between the teeth 111b and 112b of the stator core 110 and the stator coil 120, the first shoe insulating portion 1313 is a portion that insulates between the shoes 111c and 112c of the stator core 110 and the stator coil 120, and the terminal 1314 is a portion that connects the first stator coil 121 or the second stator coil 122 to the connection coil 123.

The first yoke insulating portion 1311 may protrude in the axial direction by a predetermined height. Therefore, the first yoke insulating portion 1311 may insulate between the stator core 110 and the stator coil 120, and at the same time, may insulate between the stator coil 120 and a member surrounding the same, e.g., a compressor case (not shown) including a motor case (not shown) and/or the motor.

An inner circumferential surface of the first yoke insulating portion 1311 may be formed as a linear surface to correspond to the inner circumferential surfaces 111a2 and 112a2 of the unit yokes 111a and 112a. Accordingly, a volume of the slots 111d and 112d of the stator core 110 is ensured as wide as possible, thereby increasing the space factor of the stator coil 120.

The first tooth insulating portion 1312 may be formed long inwards from the inner circumferential surface of the first yoke insulating portion 1311, and a first coil winding groove (not shown) may be formed in an axial side surface facing back toward the stator core 110. The first coil winding groove may be formed to be inclined along a direction in which the stator coil 120 is wound. Accordingly, the arrangement of the stator coil 120 is improved in winding of the stator coil 120, so that deterioration of the space factor of the stator coil 120 can be suppressed.

Although not shown in the drawings, a second coil winding groove (not shown) may be formed in the second insulator 132. The second coil winding groove may be formed in a direction intersecting the first coil winding groove in axial projection, e.g., a direction orthogonal to a circumferential side surface of the first tooth insulating portion 1312. Accordingly, the arrangement of the stator coil 120 can be improved in winding of the stator coil 120.

The first shoe insulating portion 1313 extends in both circumferential directions from an inner end of the first tooth insulating portion 1312, and may extend to both sides by a same length or may extend to both the sides by different lengths. For example, a circumferential length of the first shoe insulating portion 1313 may be formed equal to the circumferential length of the shoe 111c or may be formed longer than the circumferential length of the shoe 111c. In the case of the former, as an interval between both adjacent first shoe insulating portions 1313 is secured as wide as possible, the winding operation can be further easily performed. In the case of the latter, while both ends of the first shoe insulating portion 1313 further protrude in the circumferential direction than both ends of the shoe 111c, the insulating sheet 140 to be described later can be supported in the axial direction.

The terminal 1314 may be formed in each single first insulator 131 coupled to each unit core 111 and 112 as described above. As the stator coil 120 includes stator coils of three phases (U, V, W) in this embodiment, terminals 1314 of the three phases may be sequentially arranged such that the stator coils 120 of the three phases are connected to each other along the circumferential direction. As the terminals 1314 of the three phases are formed to be the same, the terminal 1314 for connecting the stator coil of the U phase will be mainly described below.

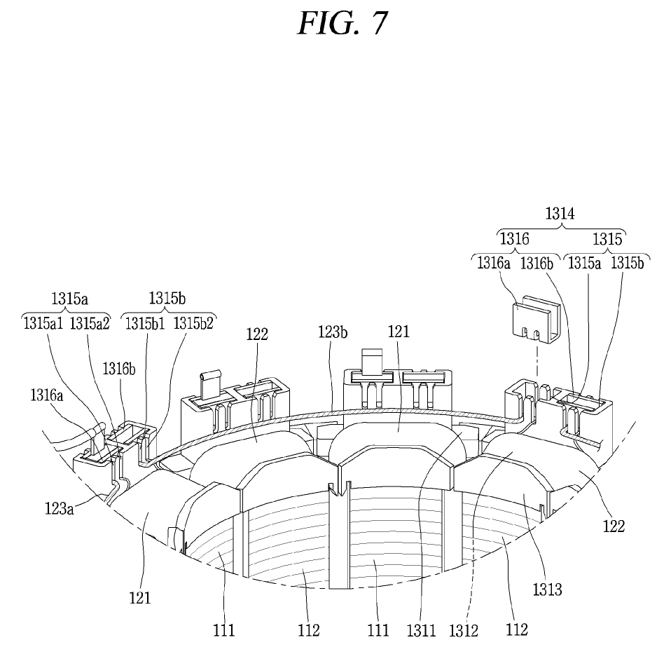

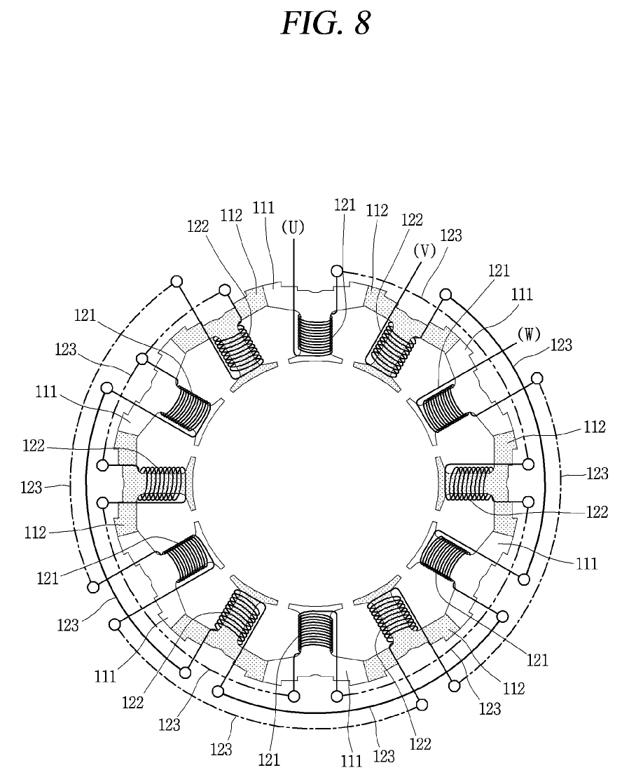

FIG. 7 is an enlarged perspective view showing a connection structure of the stator coil in the stator according to this embodiment, and FIG. 8 is a schematic view illustrating a connection state of the stator coil according to this embodiment.

The terminal 1314 according to this embodiment may be formed in the first insulator 131, may be formed in the second insulator 132, or may be formed in each of the first insulator 131 and the second insulator 132. In this embodiment, an example is illustrated in which the terminal 1314 is formed in the first insulator 131.

Referring to FIGS. 7 and 8, the terminal 1314 according to this embodiment may include a coil insertion groove 1315 and the magmate 1316. The coil insertion groove 1315 is a portion in which each of coils of the three phases is inserted, and the magmate 1316 is a portion that connects the coils inserted into the coil insertion groove 1315 to each other. Therefore, while the coil insertion groove 1315 extends as a single body in the first insulator 131 to be made of a same material as the first insulator 131, the magmate 1316 may be made of a material, i.e., a conductor, different from that of the first insulator 131.

For example, two coil insertion grooves 1315 may be formed in one terminal 1314. In other words, the coil insertion groove 1315 may be formed to be separated into a first coil insertion groove 1315a and a second coil insertion groove 1315b along the circumferential direction. In this case, a first magmate 1316a may be inserted into the first coil insertion groove 1315a, and a second magmate 1316b may be inserted into the second coil insertion groove 1315b. The first coil insertion groove 1315a and the second coil insertion groove 1315b may be formed to be the same, and the first magmate 1316a and the second magmate 1316b may be formed to be the same.

Two coil slots 1315a1 and 1315a2 may be formed in the first coil insertion groove 1315a to be spaced apart from each other by a predetermined interval along the circumferential direction, and two coil slots 1315b1 and 1315b2 may be formed in the second coil insertion groove 1315b to be spaced apart from each other by the predetermined interval along the circumferential direction. In other words, first and second coil slots 1315a1 and 1315a2 may be formed in the first coil insertion groove 1315aalong the circumferential direction, third and fourth coil slots 1315b1 and 1315b2 may be formed in the second coil insertion groove 1315b along the circumferential direction, and the second coil slot 1315a2 and the third coil slot 1315b1 may be separated from each other by a partition wall. Therefore, the first magmate 1316a inserted into the first coil insertion groove 1315a and the second magmate 1316b inserted into the second coil insertion groove 1315b may be separated from each other.

In this case, a second end of a first connection coil 123a and a first end (input end) of the first stator coil 121 may be inserted into the first coil slot 1315a1 and the second coil slot 1315a2, respectively, and a first end of a second connection coil 123b and a second end (output end) of the first stator coil 121 may be inserted into the third coil slot 1315b1 and the fourth coil slot 1315b2, respectively. The second end of the first connection coil 123a and the first end of the first stator coil 121 may be connected to each other by the first magmate 1316a inserted into the first coil insertion groove 1315a, and the first end of the second connection coil 123b and the second end of the first stator coil 121 may be connected to each other by the second magmate 1316b inserted into the second coil insertion groove 1315b. By repeating the above-described connection method, the first stator coil 121 may be electrically connected to the second stator coil 122 adjacent thereto by the first connection coil 123a and the second connection coil 123b.

Although not shown in the drawings, the connection coil 123 of the above-described embodiment may be excluded, and the first stator coil 121 and the second stator coil 122 may be connected to each other in each terminal 1314. For example, the first stator coil 121 of the U phase may be wound around the first unit core 111 of the U phase and then be inserted into the first coil insertion groove 1315a of the terminal 1314 located above or below the second unit core 112 of the U phase beyond the first unit cores 111 and 111 of the V and W phases, adjacent thereto, and the second stator coil 122 of the U phase may be wound around the second unit core 122 and then be inserted into the second coil insertion groove 1315b of the terminal 1314. Then, the magmate 1316 may be inserted into the corresponding terminal 1314, thereby connecting the first stator coil 121 of the U phase and the second stator coil 122 of the U phase to each other. The stator coils of the V and W phases may also be connected in the same manner.

By doing so, when the first unit core 111 and the second unit core 112, constituting the stator core 110, are made of different materials, i.e., when the first unit core 111 of each phase is made of a silicon steel sheet and the second unit core 112 of each phase is made of a cobalt steel sheet having a magnetic flux density higher than that of the silicon steel sheet, a yoke width and/or a tooth width of the second unit core 112 may be formed smaller than a yoke width and/or a tooth width of the first unit core 111 as described above. Accordingly, iron loss is reduced using the cobalt steel sheet having a high magnetic flux density, and the use amount of the cobalt steel sheet which is relatively high-priced is minimized, thereby minimizing an increase in material cost.

In addition, when a number of turns of the first stator coil 121 wound around the first unit core 111 and a number of turns of the second stator coil 122 wound around the second unit core 112 are the same, a coil wire diameter of the second stator coil 122 may be formed larger than a coil wire diameter of the first stator coil 121. Accordingly, by using the cobalt steel sheet, iron loss in the stator core 110 is reduced and copper loss in the stator coil 120 is reduced, thereby improving the entire motor efficiency.

Although not shown in the drawings, the first unit cores 111 and the second unit cores 112 may be variously combined according to design purposes. For example, in the stator core 110 according to the above-described embodiment, a number of the second unit cores 112 made of the cobalt steel sheet may be the same as a number of the first unit cores 111 made of the silicon steel sheet. However, in some cases, the number of the second unit cores 112 may be formed smaller than the number of the first unit cores 111, or the number of the second unit cores 112 may be formed greater than the number of the first unit cores 111. In these cases, as described above, the increase in material cost can be reduced if possible, and the motor efficiency can be improved.

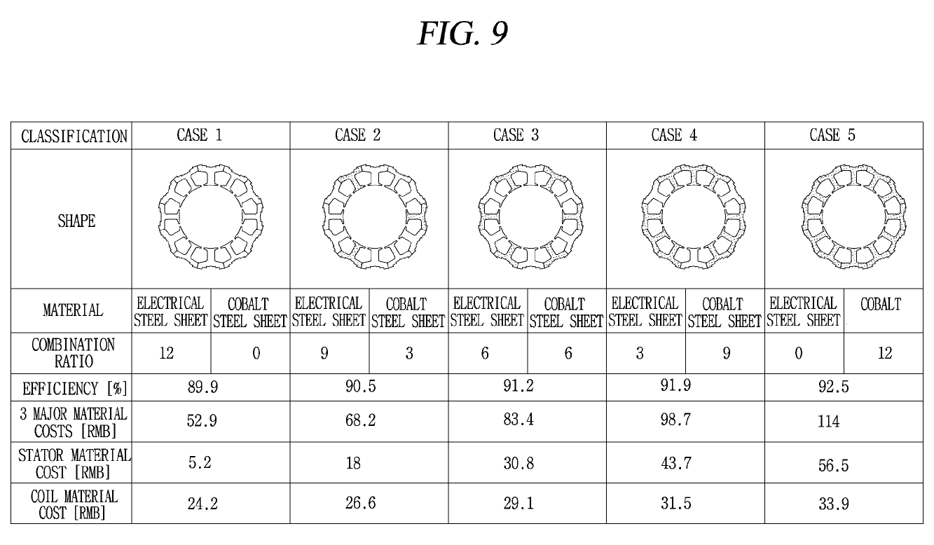

FIG. 9 is a table comparing efficiency and material cost for each arrangement of the first unit core and the second unit core in the stator according to this embodiment.

Referring to FIG. 9, Case 1 is an example in which the unit core 110a includes only the first unit cores 111 which are silicon steel sheets, Case 2 is an example in which a number of the first unit cores 111 which are silicon steel sheets is three times greater than a number of the second unit cores 112 which are cobalt steel sheets, Case 3 is an example in which a number of the first unit cores 111 and a number of the second unit cores 112 are the same, Case 4 is an example in which a number of the second unit cores 112 is three times greater than a number of the first unit cores 111, and Case 5 is an example in which the unit core 110a includes only the second unit cores 112 which are cobalt steel sheets.

In this case, in terms of motor efficiency, it can be seen that the motor efficiency which is a value obtained by dividing an output including iron loss and copper loss by an input has highest increase rates in Case 3 and Case 4 when Case 1 has a motor efficiency of 89.9%, i.e. that the motor efficiency in Case 3 increases by 0.7% as compared with Case 2 and the motor efficiency in Case 4 increases by 0.7% as compared with Case 3.

In addition, in terms of material cost of the motor, it can be seen that when material costs of a rotor and a magnet are the same, the material cost of the stator core 110 increases as approaching Case 5 in which a relatively large number of the cobalt steel sheets is applied, and the coil wire diameter of the stator coil 120 also increases by reduction in the width of the unit core as approaching Case 5, so that the material cost of the coil increases to that extent. That is, it can be seen that three major material costs defined as material cost of a core including a stator and a rotor, material cost of the magnet, and material cost of the stator coil 120 gradually increase as approaching Cast 5 from Cast 1. However, in terms of relative increase rate, an increase range in Case 3 is 22.5% which is greatest. Therefore, it can be seen that as the coil wire diameter increases to that extent, copper loss is reduced as can be seen in the above motor efficiency, so that the motor efficiency is considerably improved. Accordingly, in the stator core 110, the first unit cores 111 and the second unit cores 112 can be appropriately combined according to design purposes in various cases as described above.

What is claimed is:

1. A stator of a motor, comprising:
a stator core comprising a plurality of unit cores connected to each other to be formed in an annular shape; and
a stator coil wound around each of the plurality of unit cores,
wherein the plurality of unit cores are made of materials having different magnetic flux densities.

2. The stator of claim 1, wherein the plurality of unit cores comprise:
a first unit core having a first magnetic flux density; and
a second unit core having a second magnetic flux higher than the first magnetic flux density.

3. The stator of claim 2, wherein the first unit core and the second unit core are alternately arranged along a circumferential direction.

4. The stator of claim 2, wherein the first unit core comprises a first unit yoke and a first tooth extending from the first unit yoke,
wherein the second unit core comprises a second unit yoke and a second tooth extending from the second unit yoke, and
wherein a second tooth width defined as a width length between both circumferential ends of the second tooth is formed smaller than a first tooth width defined as a width length between both circumferential ends of the first tooth.

5. The stator of claim 4, wherein a first yoke distance defined as a distance from a center of the stator core to an inner circumferential surface of each of both ends of the first unit yoke is formed equal to a second yoke distance defined as a distance from the center of the stator core to an inner circumferential surface of each of both ends of the second unit yoke.

6. The stator of claim 5, wherein a first tooth length defined as a length from an inner circumferential surface of the first tooth to the inner circumferential surface of the first unit yoke is formed smaller than a second tooth length defined as a length from an inner circumferential surface of the second tooth to the inner circumferential surface of the second yoke.

7. The stator of claim 4, wherein a first yoke end width defined as a radial width of each of both ends of the first yoke and a second yoke end width defined as a radial width of each of both ends of the second unit yoke, which faces the end of the first yoke, are formed to be the same.

8. The stator of claim 7, wherein a first yoke middle width defined as a radial width of the first unit yoke at a point at which the inner circumferential surface of the first unit yoke and a side surface of the first tooth meet each other is formed larger than a second yoke middle width defined as a radial width of the second yoke at a point at which the inner circumferential surface of the second unit yoke and a side surface of the second tooth meet each other.

9. The stator of claim 4, wherein a first internal angle between the first unit yoke and the first tooth is formed larger than a second internal angle between the second unit yoke and the second tooth.

10. The stator of claim 9, wherein the first internal angle is formed as an obtuse angle, and the second internal angle is formed as a right angle.

11. The stator of claim 4, wherein the plurality of unit cores comprise:
a first unit core; and
a second unit core having a magnetic flux density higher than a magnetic flux density of the first unit core, and
wherein a coil wire diameter of a second stator coil wound around the second unit core is formed larger than a coil wire diameter of a first stator coil wound around the first unit core.

12. The stator of claim 11, wherein an insulator is located on each of both axial side surfaces of the stator core, and
wherein the insulator comprises a plurality of terminals, and the first stator coil and the second stator coil are connected to each other by a connection coil in at least one terminal among the plurality of terminals.

13. The stator of claim 12, wherein a coil wire diameter of the connection coil is formed equal to the coil wire diameter of the first stator coil.

14. The stator of any one of claim 2, wherein the first unit core is made of a silicon steel sheet, and the second unit core is made of a cobalt steel sheet.

15. The stator of claim 14, wherein a number of turns of a coil wound around the first unit core and a number of turns of a coil wound around the second unit core are formed to be the same.

16. A stator of a motor, comprising:
a stator core comprising a plurality of unit cores connected to each other to be formed in an annular shape, the plurality of unit cores are made of materials having different magnetic flux densities; and
a stator coil wound around each of the plurality of unit cores,
wherein the plurality of unit cores comprise:
a first unit core; and
a second unit core having a magnetic flux density higher than a magnetic flux density of the first unit core, and
wherein a coil wire diameter of a second stator coil wound around the second unit core is formed larger than a coil wire diameter of a first stator coil wound around the first unit core.

17. The stator of claim 16, wherein an insulator is located on each of both axial side surfaces of the stator core, and
wherein the insulator comprises a plurality of terminals, and the first stator coil and the second stator coil are connected to each other by a connection coil in at least one terminal among the plurality of terminals.

18. The stator of claim 17, wherein a coil wire diameter of the connection coil is formed equal to the coil wire diameter of the first stator coil.

19. A stator of a motor, comprising:
a stator core comprising a plurality of unit cores connected to each other to be formed in an annular shape; and
a stator coil wound around each of the plurality of unit cores,
wherein the plurality of unit cores comprise a first unit core and a second unit core, the first unit core and a second unit core are alternately arranged along a circumferential direction. and
wherein the first unit core is made of a silicon steel sheet, and the second unit core is made of a cobalt steel sheet.

20. The stator of claim 19, wherein a coil wire diameter of a second stator coil wound around the second unit core is formed larger than a coil wire diameter of a first stator coil wound around the first unit core, and
wherein a number of turns of a coil wound around the first unit core and a number of turns of a coil wound around the second unit core are formed to be the same.
